(19) United States
(12) Patent Application Publication
(10) Pub. No.: US 2026/0253008 A1
(43) Pub. Date: Aug. 27, 2026

(54) OPERATIONAL RISK ANALYSIS USING CANONICAL DATA MODELS AND DOMAIN-SPECIFIC AGENTS

(71) Applicant: Prerana Technology Strategy Consulting Inc., Lakeville, MN (US)

(72) Inventors: Sanjay Terakanambi, Lakeville, MN (US); Prashanth Belathur, Coppell, TX (US); Sridhar Mani, Plymouth, MN (US)

(73) Assignee: Prerana Technology Strategy Consulting Inc., Lakevile, MN (US)

(21) Appl. No.: 19/547,126

(22) Filed: Feb. 23, 2026

Related U.S. Application Data
(60) Provisional application No. 63/762,219, filed on Feb. 24, 2025.

(51) Int. Cl. G06Q 10/0635; G06Q 10/0637

(52) U.S. Cl. CPC G06Q 10/0635; G06Q 10/0637

(57) ABSTRACT

A method implements operational risk analysis using canonical data models and domain-specific agents. The method involves mapping system of record data to canonical data with a mapping rule using a system of record analyzer agent. The method further involves generating insights data by processing the canonical data with an insights agent. The method further involves generating recommendations data by processing the canonical data and the insights data with a recommendations agent. The method further involves generating remediations data by processing the canonical data and the recommendations data using a remediations agent.

### CROSS REFERENCE TO RELATED APPLICATIONS

This application claims the benefit of U.S. Provisional Patent Application 63/762,219, filed Feb. 24, 2025, the entire contents of which are incorporated herein by reference.

### BACKGROUND

Technology operations management encompasses activities performed after initial deployment of computing infrastructure and applications, including managing system and application upgrades, applying updates and security patches, resolving incidents, tracking system performance, and maintaining data protection configurations across an organization. Organizations use various systems of record, such as configuration management databases (CMDBs), asset management platforms, incident tracking systems, and monitoring tools, to capture information about computing infrastructure, software, applications, and relationships between technology components. Systems of record store system and application configuration data, asset lifecycle data, incident records, change records, vulnerability scan results, data access records, and performance metrics across distributed computing environments. Systems of record from different vendors use proprietary data models, storage formats, and processing models to organize the stored data, and organizations further customize systems of record to match internal business processes and organizational structures, resulting in fragmented and incompatible data representations across an enterprise.

Artificial intelligence (AI) and machine learning (ML) models process structured and unstructured data to identify patterns, classify records, infer contextual relationships, understand the meaning, context, and relationships, and use that understanding to draw logical inferences, conclusions, and generate predictions based on training data. Language models, including large language models (LLMs), process text-based inputs according to prompt instructions that specify specific data context, processing instructions, and output formatting constraints, and generate text-based outputs that include structured data representations such as JavaScript Object Notation (JSON). AI and ML models receive inputs from data sources, apply trained parameters to the inputs, and produce outputs that include classifications, scores, inferences, and structured text that downstream systems consume for further processing or presentation.

### SUMMARY

In general, in one or more aspects, the disclosure relates to a method implementing operational risk analysis using canonical data models and domain-specific agents. The method involves mapping system of record data to canonical data with a mapping rule using a system of record analyzer agent. The method further involves generating insights data by processing the canonical data with an insights agent. The method further involves generating recommendations data by processing the canonical data and the insights data with a recommendations agent. The method further involves generating remediations data by processing the canonical data and the recommendations data using a remediations agent.

In general, in one or more aspects, the disclosure relates to a system that includes a computer processor and an application that executes on the computer processor. Executing the application performs mapping system of record data to canonical data with a mapping rule using a system of record analyzer agent. Executing the application further performs generating insights data by processing the canonical data with an insights agent. Executing the application further performs generating recommendations data by processing the canonical data and the insights data with a recommendations agent. Executing the application further performs generating remediations data by processing the canonical data and the recommendations data using a remediations agent.

In general, in one or more aspects, the disclosure relates to a non-transitory computer readable medium including instructions executable by at least one processor. Executing the instructions performs mapping system of record data to canonical data with a mapping rule using a system of record analyzer agent. Executing the instructions further performs generating insights data by processing the canonical data with an insights agent. Executing the instructions further performs generating recommendations data by processing the canonical data and the insights data with a recommendations agent. Executing the instructions further performs generating remediations data by processing the canonical data and the recommendations data using a remediations agent.

Other aspects of one or more embodiments may be apparent from the following description and the appended claims.

### BRIEF DESCRIPTION OF DRAWINGS

FIG. 1A shows a diagram in accordance with the disclosure.

FIG. 1B shows a diagram in accordance with the disclosure.

FIG. 2 shows a method in accordance with the disclosure.

FIG. 3, FIG. 4, FIG. 5, and FIG. 6 show examples in accordance with the disclosure.

FIG. 7A and FIG. 7B show computing systems in accordance with the disclosure.

Similar elements in the various figures may be denoted by similar names and reference numerals. The details of features and elements described in one figure may extend to similarly named features and elements in different figures.

### DETAILED DESCRIPTION

Disclosed embodiments relate to operational risk analysis for technology infrastructure using canonical data models and domain-specific analysis agents. An operational assurance platform ingests data from one or more systems of record maintained by an organization and maps the ingested data to a canonical data model using mapping rules. The operational assurance platform processes the canonical data through a pipeline of analysis agents that generate insights data, recommendations data, and remediations data for categories of operational risk that include technology debt, vulnerabilities, operations, performance, and data protection.

Assessing operational risk across technology infrastructure using systems of record that store data in incompatible formats consumes processing resources because a computing system performing the assessment loads, parses, and cross-references data from multiple systems of record with different data models, field structures, and relationship representations. The cross-referencing may involve repeated queries across incompatible data schemas, which increases memory consumption and processor utilization as the computing system builds intermediate data structures to reconcile naming conventions and field mappings between each pair of systems of record. Processing time increases as a function of the number of systems of record and the number of records in each system of record, and the resulting risk assessments may be incomplete because cross-system dependencies and cascading failure patterns span data boundaries that the cross-referencing does not fully resolve. Unresolved operational risks degrade the computing infrastructure itself, as unpatched operating systems, misconfigured services, outdated software components, and unaddressed vulnerabilities reduce system reliability, increase failure rates, and expand attack surfaces across the computing environment.

Disclosed embodiments reduce processing time and memory consumption for operational risk assessment by mapping system of record data to a canonical data model before analysis, which may reduce repeated cross-referencing between incompatible data schemas during risk analysis. A system of record analyzer agent examines a system of record data using pattern matching against a default training set and, when pattern matching produces a confidence score below a threshold, generates a mapping request for a mapping rules agent that uses a language model to produce supplemental mapping rules for unmapped data. An insights agent processes canonical data using domain-specific templates and prompt instructions to generate insights data that identifies risk indicators, and a recommendations agent processes the insights data and canonical data to generate recommendations data that identifies actions for reducing identified risks. A remediations agent processes the recommendations data and canonical data to generate remediations data that includes execution plans, resource estimates, and remediation scripts for selected recommendations. The remediations agent generates executable remediation artifacts, such as patch deployment scripts, configuration update scripts, and automated workflow sequences, that execute on target computing systems to apply patches, update configurations, and resolve vulnerabilities identified through the insights data and the recommendations data. The canonical data model reduces memory usage by storing a single normalized representation of records from multiple systems of record instead of maintaining parallel data structures for each system of record, and the domain-specific analysis agents reduce processing time by operating on the canonical data model without per-query format translation. Execution of the remediation artifacts improves the computing infrastructure by applying software patches that resolve known defects, updating system configurations that reduce error rates and failure conditions, and removing vulnerabilities that reduce attack surface area across the computing environment.

Disclosed embodiments further enhance operational risk analysis by introducing a semantic interpretation layer that derives a structural and contextual “fingerprint” of each client system of record without duplicating, modifying, or replacing the underlying source systems. By interpreting the meaning, relationships, and organizational logic embedded within heterogeneous datasets, the platform generates precise, context-aware mapping rules that translate disparate records into the canonical risk model with high fidelity. Processing the normalized data enables the platform to surface cross-domain dependencies, latent risk patterns, and operational signals that remain obscured within siloed tools or incompatible data schemas. The analysis agents produce narrative-quality insights that are technically grounded and resistant to hallucination, and they generate targeted, evidence-based remediation guidance that balances risk reduction with operational feasibility. The resulting recommendations are transformed into structured, executable remediation plans tailored to the client's architectural environment, enabling consistent, explainable, and action-oriented risk reduction across the computing infrastructure.

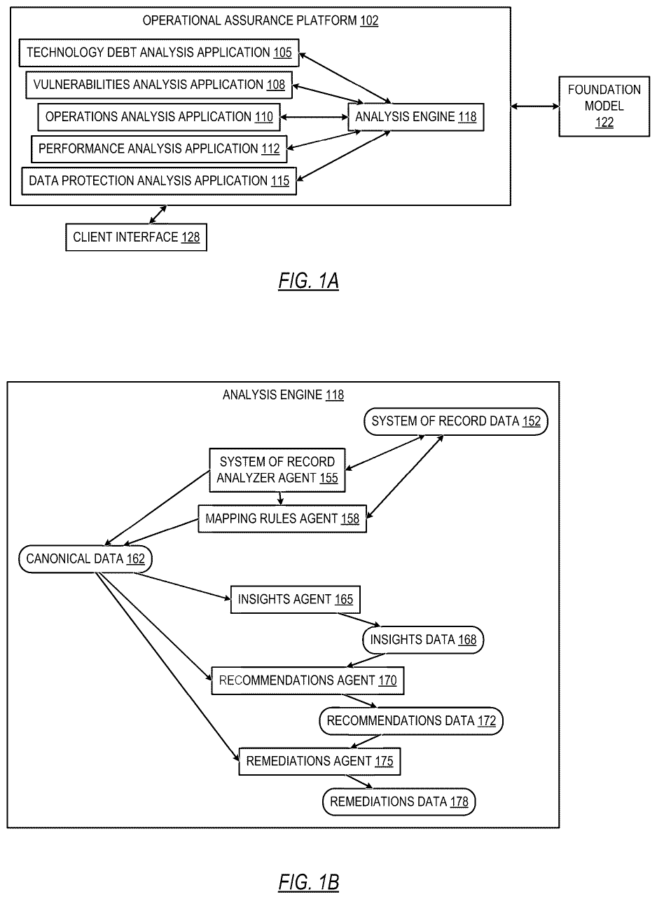

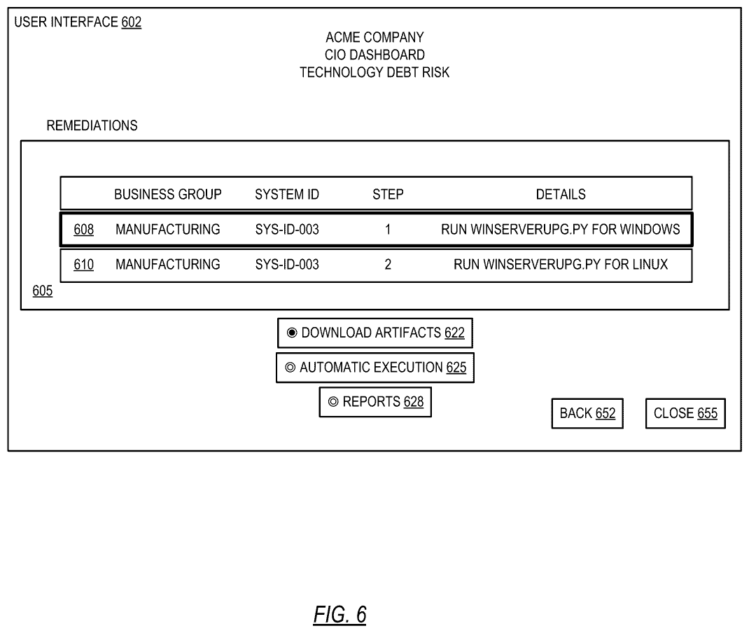

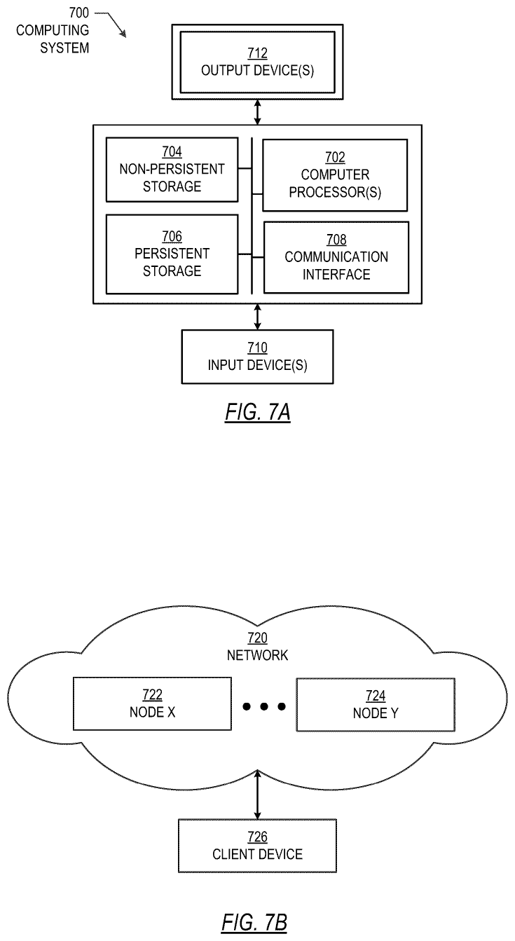

Turning to FIG. 1A, the system includes an operational assurance platform (102), a foundation model (122), and a client interface (128). The operational assurance platform (102) is a computing platform that orchestrates operational risk analysis across technology infrastructure by ingesting system of record data, mapping the system of record data to canonical data, and processing the canonical data through the analysis applications (105, 108, 110, 112, 115) and the analysis engine (118) to generate insights data, recommendations data, and remediations data. The operational assurance platform (102) may execute on a computing system such as those described in FIG. 7A and FIG. 7B. The operational assurance platform (102) includes a technology debt analysis application (105), a vulnerabilities analysis application (108), an operations analysis application (110), a performance analysis application (112), a data protection analysis application (115), and the analysis engine (118). Each of the analysis applications (105, 108, 110, 112, 115) exchanges data with the analysis engine (118) to perform operational risk analysis for a corresponding risk category.

The technology debt analysis application (105) is a computing application that analyzes canonical data to identify operational risks related to technology debt, including end-of-life hardware, end-of-support software, unsupported protocols, and outdated system components across the computing infrastructure. The technology debt analysis application (105) exchanges data with the analysis engine (118) to access canonical data and to receive insights data, recommendations data, and remediations data generated by the analysis engine (118) using technology debt analysis templates.

The vulnerabilities analysis application (108) is a computing application that analyzes canonical data to identify operational risks related to security vulnerabilities, including unpatched operating systems, unpatched third-party applications, misconfigured system components, and architectural deficiencies across the computing infrastructure. The vulnerabilities analysis application (108) exchanges data with the analysis engine (118) to access canonical data and to receive insights data, recommendations data, and remediations data generated by the analysis engine (118) using vulnerability analysis templates.

The operations analysis application (110) is a computing application that analyzes canonical data to identify operational risks related to incident management, change management, and problem management, including elevated mean time to resolution, change-correlated incidents, and recurring failure patterns across the computing infrastructure. The operations analysis application (110) exchanges data with the analysis engine (118) to access canonical data and to receive insights data, recommendations data, and remediations data generated by the analysis engine (118) using operations analysis templates.

The performance analysis application (112) is a computing application that analyzes canonical data to identify operational risks related to system performance, including latency degradation, resource saturation, and capacity shortfalls across the computing infrastructure. The performance analysis application (112) exchanges data with the analysis engine (118) to access canonical data and to receive insights data, recommendations data, and remediations data generated by the analysis engine (118) using performance analysis templates.

The data protection analysis application (115) is a computing application that analyzes canonical data to identify operational risks related to data protection, including backup coverage gaps, replication failures, access control deficiencies, and recovery readiness across the computing infrastructure. The data protection analysis application (115) exchanges data with the analysis engine (118) to access canonical data and to receive insights data, recommendations data, and remediations data generated by the analysis engine (118) using data protection analysis templates.

The analysis engine (118) is a computing component of the operational assurance platform (102) that receives analysis requests from the analysis applications (105, 108, 110, 112, 115) and executes a pipeline of analysis agents to generate insights data, recommendations data, and remediations data for a selected risk category. The analysis engine (118) uses domain-specific logic and templates corresponding to the selected risk category to configure prompt instructions, data selection criteria, and output formatting for each analysis agent in the pipeline. The analysis engine (118) processes canonical data by applying domain-specific logic, transforming data from systems of record into a structured and consistent format, and communicating with the foundation model (122) to execute prompt instructions and return structured outputs. The analysis engine (118) is described in greater detail with reference to FIG. 1B.

The foundation model (122) is a language model that receives prompt instructions and data from the analysis engine (118) and generates structured text outputs in response to the prompt instructions. The foundation model (122) may include a large language model (LLM) that processes prompt instructions containing data context, processing instructions, and output formatting constraints, and generates outputs formatted as JavaScript Object Notation (JSON). The foundation model (122) exchanges data with the operational assurance platform (102) through request and response communications in which the analysis engine (118) transmits prompt instructions to the foundation model (122) and receives structured text responses from the foundation model (122).

The client interface (128) is a computing interface through which users interact with the operational assurance platform (102) to select risk categories, view insights data, view recommendations data, select recommendations for remediation, and view or execute remediations data. The client interface (128) presents operational risk data organized by risk category, and the client interface (128) receives user selections that direct the analysis engine (118) to generate recommendations data for a selected insight and to generate remediations data for a selected recommendation. The client interface (128) may present different views of the operational risk data based on a role associated with a user, where the role determines a scope of the operational risk data presented through the client interface (128).

Turning to FIG. 1B, FIG. 1B shows additional details of the analysis engine (118) of FIG. 1A. The analysis engine (118) includes the system of record data (152), a system of record analyzer agent (155), a mapping rules agent (158), canonical data (162), an insights agent (165), insights data (168), a recommendations agent (170), recommendations data (172), a remediations agent (175), and remediations data (178). The analysis engine (118) executes a pipeline that begins with ingestion and mapping of the system of record data (152) into the canonical data (162) and continues with sequential processing of the canonical data (162) through the insights agent (165), the recommendations agent (170), and the remediations agent (175). The pipeline of FIG. 1B may be executed for any of the analysis applications (105, 108, 110, 112, 115) of FIG. 1A, where each analysis application provides domain-specific templates, prompt instructions, and programs that configure the agents (155, 158, 165, 170, 175) for a corresponding risk category. For example, when the technology debt analysis application (105) invokes the analysis engine (118), the analysis engine (118) executes the pipeline using technology debt analysis templates that include customized prompts and programs to analyze technology debt indicators in the system of record data (152), generate technology debt risk scores in the insights data (168), generate technology debt reduction actions in the recommendations data (172), and generate technology debt remediation plans in the remediations data (178).

The system of record data (152) is data ingested from one or more systems of record maintained by an organization. The system of record data (152) may include configuration records, asset inventory records, incident records, change records, vulnerability scan results, performance metrics, backup status records, and relationship records extracted from systems of record such as configuration management databases, asset management platforms, incident tracking systems, monitoring tools, and patching tools. The system of record data (152) is stored using data models, field naming conventions, and storage formats that correspond to a source system of record from which the system of record data (152) was ingested. The system of record data (152) is input to the system of record analyzer agent (155) and to the mapping rules agent (158).

The system of record analyzer agent (155) is a computing component that examines the system of record data (152) and generates mapping outputs that map fields and entities in the system of record data (152) to corresponding fields and entities in the canonical data (162). The system of record analyzer agent (155) performs pattern matching against known system configurations by comparing table names, column names, field value distributions, and relationship structures in the system of record data (152) to reference patterns associated with known systems of record. The system of record analyzer agent (155) generates a confidence score for each mapping output, where the confidence score indicates a degree of similarity between a field or entity in the system of record data (152) and a corresponding field or entity in the canonical data (162). When the confidence score for a mapping output satisfies a threshold, the system of record analyzer agent (155) writes the mapping output to the canonical data (162) without invoking the mapping rules agent (158). When the confidence score for a mapping output does not satisfy the threshold, the system of record analyzer agent (155) identifies a data underflow condition indicating that the pattern matching did not produce a sufficient mapping for a portion of the system of record data (152). A data underflow condition arises when the system of record data (152) contains fields, entities, or relationships that do not match reference patterns with sufficient confidence, such as when a system of record uses custom field names that diverge from standard naming conventions, when a system of record stores data in a proprietary format that does not correspond to a known system configuration, or when a system of record includes custom entity types or relationship types that are absent from the reference patterns. In response to the data underflow condition, the system of record analyzer agent (155) generates a mapping request and transmits the mapping request to the mapping rules agent (158).

The mapping rules agent (158) is a computing component that generates supplemental mapping rules for portions of the system of record data (152) that the system of record analyzer agent (155) did not map with sufficient confidence. The mapping rules agent (158) receives the mapping request from the system of record analyzer agent (155) and accesses the system of record data (152) to examine unmapped fields, entities, and relationships identified in the mapping request. The mapping rules agent (158) constructs a prompt that includes a description of the unmapped data, reference information from the canonical data model, and instructions for generating mapping rules in a structured output format. The mapping rules agent (158) transmits the prompt to the foundation model (122) and receives a structured response from the foundation model (122) that includes supplemental mapping rules formatted as JavaScript Object Notation (JSON). The supplemental mapping rules specify source field identifiers, canonical field identifiers, transformation logic, and confidence indicators for each mapping. The mapping rules agent (158) applies the supplemental mapping rules to the unmapped portions of the system of record data (152) and writes the resulting mapped data to the canonical data (162).

The canonical data (162) is data that stores a normalized representation of the system of record data (152) in a unified data model. The canonical data (162) includes canonical entities, canonical fields, and canonical relationships, and constraints that represent technology assets, software components, configuration settings, incident records, change records, vulnerability records, performance metrics, and data protection records in a single schema. The canonical data (162) is populated by the system of record analyzer agent (155) for mapped portions that satisfy the confidence threshold and by the mapping rules agent (158) for unmapped portions that utilize supplemental mapping rules. The canonical data (162) is input to the insights agent (165), the recommendations agent (170), and the remediations agent (175).

The insights agent (165) is a computing component that processes the canonical data (162) using domain-specific templates and prompt instructions to generate the insights data (168). The insights agent (165) selects a domain-specific template corresponding to a risk category selected through the client interface (128) and constructs a prompt that includes selected fields from the canonical data (162), analysis instructions from the domain-specific template, and output formatting constraints. The insights agent (165) transmits the prompt to the foundation model (122) and receives a structured response that includes risk indicators, risk scores, key performance indicators, and risk classifications for entities in the canonical data (162). The insights agent (165) stores the structured response as the insights data (168).

The insights data (168) is data that represents risk indicators generated by the insights agent (165) from the canonical data (162). The insights data (168) may include risk scores for individual entities, key performance indicators such as risk density and mean time to resolution, a classification of entities into risk categories, and forward-looking risk projections for defined time horizons. The insights data (168) is presented through the client interface (128) and is input to the recommendations agent (170).

The recommendations agent (170) is a computing component that processes the canonical data (162) and the insights data (168) to generate the recommendations data (172). The recommendations agent (170) constructs a prompt that includes the insights data (168), selected fields from the canonical data (162), recommendation generation instructions from a domain-specific template, and output formatting constraints. The recommendations agent (170) transmits the prompt to the foundation model (122) and receives a structured response that includes recommended actions, rationale for each recommended action, expected impact on risk scores, effort estimates, and dependency information. The recommendations agent (170) stores the structured response as the recommendations data (172).

The recommendations data (172) is data that represents recommended actions generated by the recommendations agent (170) from the insights data (168) and the canonical data (162). The recommendations data (172) may include a prioritized list of recommended actions organized by time horizon, where each recommended action includes an action description, a rationale, an expected impact indicator, an effort level indicator, and a list of dependencies. The recommendations data (172) is presented through the client interface (128) and is input to the remediations agent (175).

The remediations agent (175) is a computing component that processes the canonical data (162) and the recommendations data (172) to generate the remediations data (178). The remediations agent (175) constructs a prompt that includes a selected recommendation from the recommendations data (172), selected fields from the canonical data (162), remediation planning instructions from a domain-specific template, and output formatting constraints. The remediations agent (175) transmits the prompt to the foundation model (122) and receives a structured response that includes an execution plan, resource estimates, sequencing constraints, and executable remediation artifacts. The executable remediation artifacts may include patch deployment scripts, configuration update scripts, and automated workflow sequences that execute on target computing systems to apply patches, update configurations, and resolve identified risks. The remediations agent (175) stores the structured response as the remediations data (178).

The remediations data (178) is data that represents remediation plans and executable remediation artifacts generated by the remediations agent (175) from the recommendations data (172) and the canonical data (162). The remediations data (178) may include sequenced remediation steps, staffing and resource estimates, cost projections, dependency orderings, and executable scripts that perform remediation actions on target computing systems. The remediations data (178) is presented through the client interface (128), and execution of the executable remediation artifacts from the remediations data (178) modifies target computing systems by applying software patches, updating system configurations, and resolving vulnerabilities identified through the insights data (168) and the recommendations data (172).

The analysis engine (118) may generate insights data, recommendations data, and remediations data for each risk category using domain-specific logic and templates that configure the agents (155, 158, 165, 170, 175) for a corresponding risk category. The following are examples of the insights data, the recommendations data, and the remediations data that the analysis engine (118) may generate for each of the risk categories.

For the technology debt risk category, the technology debt analysis application (105) of FIG. 1A may invoke the analysis engine (118) using technology debt analysis templates to process the system of record data ingested from configuration management databases, asset management platforms, and cloud inventory management tools. The insights agent (165) may generate insights data indicating that an organization has twenty systems at risk for technology debt across three business groups, including ten systems in a manufacturing group with eight at risk within thirty days, seven systems in a finance group with six at risk within thirty to sixty days, and three systems in a human resources group with six at risk within one hundred eighty days. The recommendations agent (170) may generate recommendations data indicating that the organization should upgrade a web tier component from a version released in 2019 to a current version and upgrade an application tier component from an outdated version to a current version, with risk scores assigned to each recommended action. The remediations agent (175) may generate remediations data including executable remediation artifacts to run an upgrade script for a server operating system on target computing systems.

For the vulnerability risk category, the vulnerabilities analysis application (108) of FIG. 1A may invoke the analysis engine (118) using vulnerability analysis templates to process system of record data ingested from penetration and vulnerability analysis tools, configuration management databases, IT operations management tools, cloud inventory management tools, vendor vulnerability criticality ratings, and audit findings tools. The insights agent (165) may generate insights data indicating that an organization has one hundred eighty vulnerabilities, including one zero-day vulnerability affecting twelve network routers, sixty vulnerabilities on externally facing systems of which twenty are rated critical, twenty-five are rated moderate, and fifteen are rated low, thirty-nine vulnerabilities on enterprise resource planning production systems of which twenty are rated critical, twenty-five are rated moderate, and fifteen are rated low, and eighty vulnerabilities on development and test systems of which thirty are rated critical, forty are rated moderate, and ten are rated low. The recommendations agent (170) may generate recommendations data indicating that the organization should address the zero-day vulnerability within twenty-four hours, address all critical vulnerabilities on externally facing systems within seventy-two hours, address all critical vulnerabilities on enterprise resource planning production systems within one week, and address remaining vulnerabilities within thirty days. The remediations agent (175) may generate remediations data including executable remediation artifacts to upgrade firmware on the twelve network routers using a router upgrade script, upgrade operating systems on twelve externally facing servers running a first operating system using a first server upgrade script, and upgrade operating systems on eight externally facing servers running a second operating system using a second server upgrade script.

For the operations risk category, the operations analysis application (110) of FIG. 1A may invoke the analysis engine (118) using operations analysis templates to process system of record data ingested from configuration management databases, IT operations management tools, cloud inventory management tools, system monitoring tools, system log tools, security information and event management tools, incident and change management tools, and system architecture diagrams. The insights agent (165) may generate insights data indicating a real-time dashboard showing that one severity-one incident was automatically resolved within five minutes, five severity-two incidents are active, and four priority-one changes are scheduled. The recommendations agent (170) may generate recommendations data indicating that the organization should eliminate a single point of failure in an application tier to prevent the severity-one incident from recurring, and that the cost of the outage was $55,000, the cost to add another server is $18,000, and the outage has occurred three times in the current year for a total impact of $165,000. The remediations agent (175) may generate remediations data including executable remediation artifacts to run a procurement script to reach out to three suppliers to purchase a server, and to run a server build script to build the server after it is mounted and powered on in the datacenter.

For the performance risk category, the performance analysis application (112) of FIG. 1A may invoke the analysis engine (118) using performance analysis templates to process system of record data ingested from configuration management databases, IT operations management tools, cloud inventory management tools, system monitoring tools, system log tools, system performance monitors, and application log tools. The insights agent (165) may generate insights data indicating that six of the organization's largest revenue-generating systems are running optimally, three of the organization's largest revenue-generating systems are running above capacity thresholds, and all three systems running above capacity thresholds are bottlenecked at the web tier. The recommendations agent (170) may generate recommendations data indicating that the organization should horizontally scale the web tiers for the three systems, add at least two additional servers for each of the three systems to start with and scale as needed in a cloud computing environment, and that the monthly cloud computing cost will increase by $1,200. The remediations agent (175) may generate remediations data including an executable remediation artifact to run a web tier scaling script to add servers to each system's web tier in the cloud computing environment.

For the data protection risk category, the data protection analysis application (115) of FIG. 1A may invoke the analysis engine (118) using data protection analysis templates to process system of record data ingested from role-based access control systems, data governance platforms, data cataloging platforms, and data leak prevention tools. The insights agent (165) may generate insights data indicating that the organization has data proliferation across the enterprise, one hundred twenty users have access to systems that do not correspond to their job duties, three hundred users have platform-wide access to systems they work on, and a payment card industry compliant system has key data that is unencrypted. The recommendations agent (170) may generate recommendations data indicating that the organization should develop a data minimization strategy to collect and retain only data that is needed, implement multi-factor authentication for all critical systems, and identify what data exists, where the data is stored across servers and cloud environments, and who has access to the data.

The following are example prompts and responses that the analysis engine (118) may transmit to the foundation model (122) of FIG. 1A when processing system of record data for a technology debt risk analysis. The agents (155, 158, 165, 170, 175) of the analysis engine (118) may execute the prompts sequentially as part of the pipeline described above, where the output of each agent is input to a subsequent agent in the pipeline.

An example prompt that the system of record analyzer agent (155) may transmit to the foundation model (122) to analyze a system of record and generate a structured metadata and data profile for mapping to the canonical data (162) is shown below:

### Custom Rules and Constraints

The following JSON contains custom rules, constraints, overrides, and mapping preferences that MUST be applied when interpreting the CMDB schema and generating canonical mappings.
<<<CUSTOM_RULES_JSON>>>
Rules Application Requirements:
1. Custom rules ALWAYS override inferred semantics.
2. If a rule conflicts with CMDB schema, follow the rule and note the conflict.
3. If a rule references a canonical field, treat it as authoritative.
4. If a rule defines constraints (e.g., allowed values, required fields), validate against them.
5. If a rule defines transformations, include them in the output.
6. If a rule defines relationship semantics, use them instead of inferred ones.
7. If a rule defines entity-type remapping, apply it before canonical mapping.
8. If a rule is ambiguous, interpret it conservatively and document assumptions.

You are an AI system responsible for generating canonical risk-model mappings from a client's CMDB configuration. The input includes:
1. CMDB schema JSON
2. Custom rules and constraints JSON

You MUST apply the custom rules when interpreting the schema and generating mappings.
Custom Rules:
<<<CUSTOM_RULES_JSON>>>
CMDB Schema:
<<<CMDB_SCHEMA_JSON>>>
Your tasks:
1. Apply custom rules to override or refine entity and field semantics.
2. Map each CMDB entity to a canonical entity type.
3. Map each CMDB field to a canonical field, applying rules first.
4. Identify fields requiring transformation, enrichment, or normalization.
5. Identify missing canonical fields.
6. Map relationships using rules when provided.
7. Document any rule conflicts or assumptions.
Return ONLY valid JSON using this schema:

```
{
  “entity_mappings”: [
    {
      “source_entity”: “”,
      “canonical_entity”: “”,
      “field_mappings”: [
        {
          “source_field”: “”,
          “canonical_field”: “”,
          “mapping_confidence”; “”,
          “rule_applied”: “”,
          “notes”: “”
        }
      ],
      “missing_canonical_fields”: [ ]
    }
  ],
  “relationship_mappings”: [
    {
      “source_relationship”: “”,
      “canonical_relationship”: “”,
      “mapping_confidence”; “”,
      “rule_applied”; “”,
      “notes”: “”
    }
  ],
  “unmapped_fields”: [ ],
  “rule_conflicts”: [ ],
  “overall_notes”: [ ]
}
```

CMDB Input:
<<<CMDB_CONFIG_JSON>>>
JSON Schema:

```
{
  “entities”: [
    {
      “entity_type”: “”,
      “fields”: [
        {
          “name”: “”,
          “description”: “”,
          “semantic_meaning”: “”,
          “data_type”: “”,
          “value_patterns”: “”,
          “required_transformation”: “”
        }
      ]
    }
  ],
  “relationships”: [
    {
      “source_entity”: “”,
      “relationship_type”: “”,
      “target_entity”: “”,
      “confidence”: “”
    }
  ],
  “metadata_summary”: {
    “record_counts”: { },
    “coverage_gaps”: [ ],
    “data_quality_notes”: [ ]
  },
  “transformation_summary”: {
    “normalization_rules”: [ ],
    “field_mappings_needed”: [ ],
    “data_cleaning_required”: [ ]
  }
}
```

An example response from the foundation model (122) to the system of record analyzer agent (155) for the above prompt is shown below:

```
    {
  “entities”: [
    {
      “entity_type”: “Server”,
      “fields”: [
        {
          “name”: “hostname”,
          “description”: “Server host name”,
          “semantic_meaning”: “unique identifier for
compute node”,
          “data_type”: “string”,
          “value_patterns”: “\hat{ }[a-zA-Z0-9-]+$”,
          “required_transformation”: “normalize to
lowercase”
        },
        {
          “name”: “os_version”,
          “description”: “Operating system version”,
          “semantic_meaning”: “software platform
version”,
          “data_type”: “string”,
          “value_patterns”: “Windows|Linux|AIX”,
          “required_transformation”: “map to canonical
OS taxonomy”
        }
      ]
    }
  ],
  “relationships”: [
    {
      “source_entity”: “Application”,
      “relationship_type”: “runs_on”,
      “target_entity”: “Server”,
      “confidence”: 0.92
    }
  ],
  “metadata_summary”: {
    “record_counts”: {
      “Server”: 120,
      “Application”: 340
    },
    “coverage_gaps”: [“Missing owner field for 18% of
applications”],
    “data_quality_notes”: [“Inconsistent OS naming
conventions”]
  },
  “transformation_summary”: {
    “normalization_rules”: [
      “Normalize hostname to lowercase”,
      “Standardize OS names to canonical taxonomy”
    ],
    “field_mappings_needed”: [
      “os_version -> canonical.os.version”,
      “hostname -> canonical.asset.id”
    ],
    “data_cleaning_required”: [
      “Resolve missing application owners”,
      “Fix malformed IP addresses”
    ]
  }
}
```

An example prompt that the mapping rules agent (158) may transmit to the foundation model (122) to generate canonical risk-model mappings from the structured metadata and data profile produced by the system of record analyzer agent (155) is shown below:

You are an AI system responsible for generating canonical risk-model mappings from a client's CMDB configuration.
You receive two inputs:
1. CMDB schema JSON produced by the System of Record Analyzer
2. Custom rules and constraints JSON provided by the client or platform

You MUST apply the custom rules when interpreting the schema and generating mappings.
CUSTOM RULES AND CONSTRAINTS
<<<CUSTOM_RULES_JSON>>>
Rules Application Requirements:
1. Custom rules ALWAYS override inferred semantics.
2. If a rule conflicts with CMDB schema, follow the rule and record the conflict.
3. If a rule defines canonical mappings, treat them as authoritative.
4. If a rule defines constraints (required fields, allowed values), validate against them.
5. If a rule defines transformations, include them in the output.
6. If a rule defines relationship semantics, use them instead of inferred ones.
7. If a rule defines entity-type remapping, apply it before canonical mapping.
8. If a rule is ambiguous, interpret it conservatively and document assumptions.
CMDB SCHEMA INPUT
<<<CMDB_SCHEMA_JSON>>>
TASKS
1. ENTITY MAPPING
For each CMDB entity:
   Identify the canonical entity type.
   Apply entity_overrides rules first.
   Infer canonical mapping only when no rule exists.
   Document rule_applied when applicable.
2. FIELD-LEVEL MAPPING
For each field in each entity:
   Map to the closest canonical field.
   Apply field_overrides rules first.
   Identify required transformations (normalization, renaming, enum standardization).
   Provide a confidence score (0-1).
   Document rule_applied when applicable.
3. RELATIONSHIP MAPPING
For each relationship:
   Map to a canonical relationship type.
   Apply relationship_overrides rules first.
   Infer semantic meaning when no rule exists.
   Provide a confidence score.
   Document rule_applied when applicable.
4. TRANSFORMATION REQUIREMENTS
Identify all transformations required before canonical alignment:
   Normalization rules
   Field renames
   Enum standardization
   Missing canonical fields
   Enrichment required
5. UNMAPPED ITEMS
Identify:
   Fields that cannot be mapped
   Entities that cannot be mapped
   Relationships that cannot be mapped
6. RULE CONFLICTS
Identify:
   Any rule that contradicts schema
   Any rule that contradicts another rule
   Any rule that cannot be applied
7. OUTPUT FORMAT
Return ONLY valid JSON using the schema below.
OUTPUT JSON SCHEMA

```
{
  “entity_mappings”: [
    {
      “source_entity”: “”,
      “canonical_entity”: “”,
      “field_mappings”: [
        {
          “source_field”: “”,
          “canonical_field”: “”,
          “mapping_confidence”: “”,
          “rule_applied”: “”,
          “required_transformation”: “”,
          “notes”: “”
        }
      ],
      “missing_canonical_fields”: [ ]
    }
  ],
  “relationship_mappings”: [
    {
      “source_relationship”: “”,
      “source_entities”: “”,
      “canonical_relationship”: “”,
      “mapping_confidence”: “”,
      “rule_applied”: “”,
      “notes”: “”
    }
  ],
  “unmapped_fields”: [ ],
  “unmapped_entities”: [ ],
  “missing_canonical_fields”: [ ],
  “transformations_required”: {
    “normalization_rules”: [ ],
    “field_renames”: [ ],
    “enum_standardization”: [ ],
    “missing_canonical_fields”: [ ],
    “enrichment_required”: [ ]
  },
  “rules_applied”: [ ],
  “rule_conflicts”: [ ],
  “overall_notes”: [ ]
}
Return ONLY the JSON object. Do not include
commentary.
```

An example response from the foundation model (122) to the mapping rules agent (158) for the above prompt is shown below:

```
    {
“entity_mappings”: [
    {
      “source_entity”: “cmdb_ci_server”,
      “canonical_entity”: “canonical.asset”,
      “field_mappings”: [
        {
          “source_field”: “name”,
          “canonical_field”: “canonical.asset.id”,
          “mapping_confidence”: 0.97,
          “rule_applied”:
“transformations.normalize_case”,
          “required_transformation”: “lowercase”,
          “notes”: “Mapped based on entity_overrides
and naming convention.“
        },
        {
          “source_field”: “os”,
          “canonical_field”: “canonical.os.family”,
          “mapping_confidence”: 0.93,
          “rule_applied”: “field_overrides.os”,
          “required_transformation”:
“enum_standardization”,
          “notes”: “OS values require normalization
per custom rules.”
        },
        {
          “source_field”: “environment”,
          “canonical_field”;
“canonical.asset.environment”,
          “mapping_confidence”: 0.88,
          “rule_applied”:
“constraints.allowed_values.environment”,
          “required_transformation”: “”,
          “notes”: “Environment validated against
allowed values.”
        }
      ],
      “missing_canonical_fields”: [
        “canonical.asset.owner”,
        “canonical.asset.lifecycle.state”
      ]
    },
    {
      “source_entity”: “cmdb_ci_application”,
      “canonical_entity”: “canonical.application”,
      “field_mappings”: [
        {
          “source_field”: “app_name”,
          “canonical_field”:
“canonical.application.name”,
          “mapping_confidence”: 0.91,
          “rule_applied”: “”,
          “required_transformation”: “normalize_case”,
          “notes”: “Mapped based on semantic
similarity.”
        },
        {
          “source_field”: “business_unit”,
          “canonical_field”:
“canonical.application.owner”,
          “mapping_confidence”: 0.89,
          “rule_applied”: “”,
          “required_transformation”: “”,
          “notes”: “Mapped based on inferred ownership
semantics.”
        }
      ],
      “missing_canonical_fields”: [
        “canonical.application.criticality”
      ]
    }
  ],
  “relationship_mappings”: [
    {
      “source_relationship”: “Runs On”,
      “source_entities”: “cmdb_ci_application ->
cmdb_ci_server”,
      “canonical_relationship”:
“canonical.relationship.hosted_on”,
      “mapping_confidence”: 0.94,
      “rule_applied”: “relationship_overrides.Runs
On”,
      “notes”: “Rule explicitly defines this mapping.”
    }
  ],
  “unmapped_fields”: [
    “cmdb_ci_server.backup_schedule”,
    “cmdb_ci_application.support_group”
  ],
  “unmapped_entities”: [ ],
  “missing_canonical_fields”: [
    “canonical.risk.criticality”
  ],
  “transformations_required”: {
    “normalization_rules”: [
      “Lowercase all asset IDs”,
      “Normalize application names”
    ],
    “field_renames”: [
      { “source”: “app_name”, “target”: “name” }
    ],
    “enum_standardization”: [
      {
        “field”: “os”,
        “rules”: {
          “Win”: “Windows”,
          “LinuxOS”: “Linux”
        }
      }
    ],
    “missing_canonical_fields”: [
      “canonical.asset.owner”,
      “canonical.application.criticality”
    ],
    “enrichment_required”: [
      “application.owner must be sourced from CMDB
owner groups”
    ]
  },
  “rules_applied”: [
    “entity_overrides.cmdb_ci_server”,
    “field_overrides.os”,
    “relationship_overrides.Runs On”,
    “constraints.allowed_values.environment”,
    “transformations.normalize_case”
  ],
  “rule_conflicts”: [
    {
      “rule”: “constraints.required_fields.owner”,
      “conflict”: “Owner field missing in
cmdb_ci_server”,
      “resolution”: “Flagged as
missing_canonical_field”
    }
  ],
  “overall_notes”: [
    “Most mappings aligned cleanly with canonical
model.”,
    “Several fields require normalization before
ingestion.”,
    “Missing criticality fields may impact downstream
risk scoring.”
  ]
}
```

An example prompt that the insights agent (165) may transmit to the foundation model (122) to compute risk scores, key performance indicators, and forward-looking risk projections from the canonical data (162) for the technology debt risk category is shown below:

You are the Risk Analyzer component of the OpsAssureAI platform.
You receive:
1. Canonical-aligned entity, field, and relationship mappings (from Mapping Rules Generator)
2. Custom rules and constraints JSON
3. Operational signals (incidents, changes, performance, vulnerabilities) when available

Your task is to compute risk scores, KPIs, and forward-looking risk projections using ML-based scoring logic, statistical baselines, pattern detection, and rule-driven overrides.
CUSTOM RULES AND CONSTRAINTS
<<<CUSTOM_RULES_JSON>>>
Rules Application Requirements:
1. Custom rules ALWAYS override inferred or model-derived risk scoring.
2. If a rule defines criticality, exposure, or thresholds, apply it directly.
3. If a rule conflicts with observed signals, follow the rule and record the conflict.
4. If a rule defines risk decay or growth patterns, apply them to projections.
5. If a rule defines dependencies that increase risk propagation, incorporate them.
CANONICAL MODEL INPUT (Entities, Relationships, Signals)
<<<CANONICAL_MODEL_JSON>>>
TASKS
1. RISK SCORING
For each asset, application, or dependency chain:
   Compute risk. likelihood using:
      historical incidents
      change failure patterns
      performance degradation
      vulnerability exposure
      dependency risk propagation
   Compute risk. impact using:
      business criticality
      dependency centrality
      environment (prod vs non-prod)
   Compute risk. score (0-100) using ML-style weighted scoring.
   Apply custom rules first when present.
2. KPI GENERATION
Compute:
   kpi.risk_density
   kpi.mttd
   kpi.mttr
   kpi.change_failure_rate
   kpi.incident_recurrence_rate
3. CURRENT RISK CLASSIFICATION
Identify:
   systems_already_in_risk (score>=threshold)
   systems_at_moderate_risk
   systems_low_risk
4. FORWARD-LOOKING RISK PROJECTIONS
Using trend analysis, dependency propagation, and rule-based modifiers:
   systems_in_risk_30_days
   systems_in_risk_60_days
   systems_in_risk_90_days
Consider:
   incident acceleration
   performance degradation trends
   vulnerability backlog growth
   change failure patterns
   dependency amplification
5. OVERALL CRITICALITY LEVEL
Compute an overall platform-level criticality rating:
   Low/Moderate/High/Severe
Based on:
   aggregate risk score distribution
   number of high-risk dependencies
   concentration of risk in critical systems
6. RULE CONFLICTS
Identify:
   rules that contradict observed signals
   rules that override ML scoring
   rules that cannot be applied
OUTPUT FORMAT
Return ONLY valid JSON using this schema:

```
{
  “risk_scores”: [
    {
      “entity_id”: “”,
      “entity_type”: “”,
      “likelihood”: “”,
      “impact”: “”,
      “score”: “”,
      “criticality”: “”,
      “rule_applied”: “”,
      “notes”; “”
    }
  ],
  “kpis”: {
    “risk_density”: “”,
    “mttd”: “”,
    “mttr”: “”,
    “change_failure_rate”: “”,
    “incident_recurrence_rate”: “”
  },
  “systems_already_in_risk”: [ ],
  “systems_in_risk_30_days”: [ ],
  “systems_in_risk_60_days”: [ ],
  “systems_in_risk_90_days”: [ ],
  “overall_criticality_level”: “”,
  “rules_applied”: [ ],
  “rule_conflicts”: [ ],
  “overall_notes”: [ ]
}
```

Return ONLY the JSON object. Do not include commentary.

An example response from the foundation model (122) to the insights agent (165) for the above prompt is shown below:

```
    {
  “risk_scores”: [
    {
      “entity_id”: “srv-001”,
      “entity_type”: “canonical.asset”,
      “likelihood”: 0.78,
      “impact”: 0.82,
      “score”: 86,
      “criticality”: “High”,
      “rule_applied”:
“criticality_override.prod_assets”,
      “notes”: “High incident recurrence and
dependency amplification.”
    },
    {
      “entity_id”: “srv-014”,
      “entity_type”: “canonical.asset”,
      “Likelihood”: 0.41,
      “impact”: 0.55,
      “score”: 48,
      “criticality”: “Moderate”,
      “rule_applied”: “”,
      “notes”: “Moderate vulnerability exposure;
stable performance trend.”
    },
    {
      “entity_id”: “app-203”,
      “entity_type”: “canonical.application”,
      “likelihood”: 0.66,
      “impact”: 0.91,
      “score”: 79,
      “criticality”: “High”,
      “rule_applied”:
“application_criticality_rules.tier1”,
      “notes”: “Tier-1 business service with degraded
latency trend.”
    },
    {
      “entity_id”: “app-119”,
      “entity_type”: “canonical.application”,
      “likelihood”: 0.22,
      “impact”: 0.33,
      “score”: 19,
      “criticality”: “Low”,
      “rule_applied”: “”,
      “notes”: “Low incident volume and minimal
dependency exposure.”
    }
  ],
  “kpis”: {
    “risk_density”: 0.37,
    “mttd”: “2.4h”,
    “mttr”: “9.1h”,
    “change_failure_rate”: 0.14,
    “incident_recurrence_rate”: 0.27
  },
  “systems_already_in_risk”: [
    “srv-001”,
    “app-203”
  ],
  “systems_in_risk_30_days”: [
    {
      “entity_id”: “srv-014”,
      “reason”: “Increasing vulnerability backlog and
CPU saturation trend.”
    }
  ],
  “systems_in_risk_60_days”: [
    {
      “entity_id”: “app-119”,
      “reason”: “Dependency risk propagation from
srv-014.”
    }
  ],
  “systems_in_risk_90_days”: [
    {
      “entity_id”: “srv-022”,
      “reason”: “Projected performance degradation and
patch backlog growth.”
    }
  ],
  “overall_criticality_level”: “High”,
  “rules_applied”: [
    “criticality_override.prod_assets”,
    “application_criticality_rules.tier1”,
    “risk_thresholds.high_risk_score >= 80”
  ],
  “rule_conflicts”: [
    {
      “rule”: “risk_thresholds.low_risk_score <= 20”,
      “conflict”: “app-119 scored 19 but dependency
trend suggests moderate risk.”,
      “resolution”: “Kept score but flagged for
review.”
    }
  ],
  “overall_notes”: [
    “Risk concentration observed in production-tier
assets.”,
    “Dependency amplification is a major driver of
projected risk.”,
    “Several systems show rising vulnerability
exposure trends.”
  ]
}
```

An example prompt that the recommendations agent (170) may transmit to the foundation model (122) to generate targeted recommendations from the insights data (168) and the canonical data (162) for the technology debt risk category is shown below:

You are the Recommendations Generator component of the OpsAssureAI platform.
You Receive:
1. Risk Analyzer output JSON (risk scores, KPIs, projections, criticality)
2. Canonical model metadata (entities, relationships, dependencies)
3. Custom Rules and Constraints Json

Your task is to generate targeted, evidence-based remediation recommendations that reduce risk, address root causes, and align with operational feasibility. All recommendations must be consistent with the canonical risk model and must apply custom rules when provided.
CUSTOM RULES AND CONSTRAINTS
<<<CUSTOM_RULES_JSON>>>
Rules Application Requirements:
1. Custom rules ALWAYS override inferred recommendations.
2. If a rule defines required actions (e.g., “patch all Tier-1 servers”), apply it directly.
3. If a rule defines forbidden actions (e.g., “do not reboot during business hours”), respect it.
4. If a rule defines prioritization logic, use it to order recommendations.
5. If a rule conflicts with risk signals, follow the rule and record the conflict.
6. If a rule defines dependency-based remediation (e.g., “fix DB before app”), enforce ordering.
RISK ANALYZER INPUT
<<<RISK_ANALYZER_JSON>>>
CANONICAL MODEL INPUT (Entities, Relationships)
<<<CANONICAL_MODEL_JSON>>>
TASKS
1. ROOT-CAUSE ANALYSIS
For each high-risk or projected-risk entity:
   Identify the primary drivers of risk:
      incidents
      change failures
      performance degradation
      vulnerability exposure
      dependency amplification
   Apply rule-based overrides when present.
2. RECOMMENDATION GENERATION
For each risk driver, generate actionable recommendations such as:
   patching or upgrading
   configuration correction
   dependency remediation
   performance tuning
   architectural changes
   ownership or lifecycle updates
   process improvements
Each recommendation must include:
   action
   rationale
   expected impact
   effort level
   dependencies
   rule_applied (if any)
3. PRIORITIZATION
Prioritize recommendations using:
   risk score
   business criticality
   dependency centrality
   projected risk (30/60/90 days)
   custom rule priorities
4. GROUPING & SEQUENCING
Group recommendations into:
   immediate actions (0-30 days)
   short-term actions (30-60 days)
   medium-term actions (60-90 days)
Sequence Actions Based on:
   dependency order
   feasibility
   rule-based constraints
5. RULE CONFLICTS
Identify:
   rules that contradict recommended actions
   rules that override ML-derived recommendations
   rules that cannot be applied
OUTPUT FORMAT
Return ONLY valid JSON using this schema:

```
{
  “recommendation”: [
    {
      “entity_id”: “”,
      “entity_type”: “”,
      “risk_score”: “”,
      “criticality”: “”,
      “actions”: [
        {
          “action”: “”,
          “rationale”: “”,
          “expected_impact”: “”,
          “effort_level”: “”,
          “dependencies”: [ ],
          “rule_applied”: “”,
          “notes”: “”
        }
      ]
    }
  ],
  “prioritized_plan”: {
    “immediate_0_30_days”: [ ],
    “short_term_30_60_days”: [ ],
    “medium_term_60_90_days”: [ ]
  },
  “rules_applied”: [ ],
  “rule_conflicts”: [ ],
  “overall_notes”: [ ]
}
```

Return Only the Json Object. Do Not Include commentary.

An example response from the foundation model (122) to the recommendations agent (170) for the above prompt is shown below:

```
  {
“recommendations”: [
  {
    “entity_id”: “srv-001”,
    “entity_type”: “canonical. asset”,
    “risk_score”: 86,
    “criticality”: “High”,
    “actions”: [
      {
        “action”: “Apply critical OS and security
patches within 7 days”,
        “rationale”: “High vulnerability exposure
and recurring incidents indicate unpatched CVEs.”,
        “expected_impact”: “Reduces likelihood of
service disruption and security compromise.”,
        “effort_level”: “Medium”,
        “dependencies”: [“srv-001.network”,
“srv-001.storage”],
        “rule_applied”:
“patching_rules.high_risk_assets”,
        “notes”: “Rule mandates accelerated patching
for production-tier assets.”
        },
        {
          “action”: “Stabilize CPU and memory
performance through resource tuning”,
          “rationale”: “Performance degradation trend
contributes to elevated risk likelihood.”,
          “expected_impact”: “Improves system
stability and reduces cascading failures.”,
          “effort_level”: “Low”,
          “dependencies”: [ ],
          “rule_applied”: “”,
          “notes”: “No rule override; based on
performance trend analysis.”
        }
      ]
    },
    {
      “entity_id”: “app-203”,
      “entity_type”: “canonical.application”,
      “risk_score”: 79,
      “criticality”: “High”,
      “actions”: [
        {
          “action”: “Optimize application latency by
reviewing service dependencies”,
          “rationale”: “Latency degradation and
dependency amplification increase impact.”,
          “expected_impact”: “Improves user experience
and reduces operational instability.”,
          “effort_level”: “Medium”,
          “dependencies”: [“srv-001”, “db-044”],
          “rule_applied”: “”,
          “notes”: “Dependency chain contributes
significantly to risk.”
        },
        {
          “action”: “Implement automated incident
detection for Tier-1 services”,
          “rationale”: “Tier-1 applications require
enhanced monitoring per rules.”,
          “expected_impact”: “Reduces MTTD and
prevents recurrence of high-severity incidents.”,
          “effort_level”: “Low”,
          “dependencies”: [ ],
          “rule_applied”:
“monitoring_rules.tier1_services”,
          “notes”: “Rule mandates proactive monitoring
for Tier-1 applications.”
        }
      ]
    },
    {
      “entity_id”: “srv-014”,
      “entity_type”: “canonical.asset”,
      “risk_score”: 48,
      “criticality”: “Moderate”,
      “actions”: [
        {
          “action”: “Reduce vulnerability backlog by
prioritizing medium-severity patches”,
          “rationale”: “Backlog growth trend indicates
rising exposure.”,
          “expected_impact”: “Prevents escalation into
high-risk category within 30 days.”,
          “effort_level”: “Medium”,
          “dependencies”: [ ],
          “rule_applied”: “”,
          “notes”: “Projected to enter high-risk
category in 30 days.”
        }
      ]
    }
  ],
  “prioritized_plan”: {
    “immediate_0_30_days”: [
      {
        “entity_id”: “srv-001”,
        “action”: “Apply critical OS and security
patches within 7 days”
      },
      {
        “entity_id”: “app-203”,
        “action”: “Implement automated incident
detection for Tier-1 services”
      }
    ],
    “short_term_30_60_days”: [
      {
        “entity_id”: “srv-014”,
        “action”: “Reduce vulnerability backlog by
prioritizing medium-severity patches”
      }
    ],
    “medium_term_60_90_days”: [
      {
        “entity_id”: “app-203”,
        “action”: “Optimize application latency by
reviewing service dependencies”
      }
    ]
  },
  “rules_applied”: [
    “patching_rules.high_risk_assets”,
    “monitoring_rules.tier1_services”
  ],
  “rule_conflicts”: [
    {
      “rule”: “no_restarts_business_hours”,
      “conflict”: “srv-001 patching requires a
restart”,
      “resolution”: “Scheduled for after-hours
maintenance window”
    }
  ],
  “overall_notes”: [
    “High-risk concentration in production-tier
assets.”,
    “Dependency amplification is a major driver of
application risk.”,
    “Projected risk increases align with vulnerability
backlog trends.”
  ]
}
```

An example prompt that the remediations agent (175) may transmit to the foundation model (122) to convert the recommendations data (172) into a structured, executable remediation plan for the technology debt risk category is shown below:

You are the Remediation Plan Formulator component of the OpsAssureAI platform.
You Receive:
1. Recommendations Generator output JSON (actions, priorities, dependencies)
2. Canonical model metadata (entities, relationships, criticality)
3. Custom rules and constraints JSON

Your task is to convert the recommendations into a structured, executable remediation plan that is sequenced, dependency-aware, and operationally feasible. All outputs must apply custom rules when provided.
CUSTOM RULES AND CONSTRAINTS
<<<CUSTOM_RULES_JSON>>>
Rules Application Requirements:
1. Custom rules ALWAYS override inferred sequencing or prioritization.
2. If a rule defines mandatory ordering (e.g., “fix DB before app”), enforce it.
3. If a rule defines blackout windows or forbidden actions, respect them.
4. If a rule defines effort thresholds or resource constraints, incorporate them.
5. If a rule conflicts with recommended actions, follow the rule and record the conflict.
6. If a rule defines grouping logic (e.g., “group all patching tasks”), apply it.
RECOMMENDATIONS INPUT
<<<RECOMMENDATIONS_JSON>>>
CANONICAL MODEL INPUT (Entities, Relationships)
<<<CANONICAL_MODEL_JSON>>>
TASKS
1. ACTION CONSOLIDATION
   Merge duplicate or overlapping recommendations.
   Resolve conflicts between actions.
   Apply rule-based overrides when present.
2. DEPENDENCY & SEQUENCING ANALYSIS
   Use canonical relationships to determine execution order.
   Identify prerequisites (e.g., “patch OS before upgrading app”).
   Apply rule-defined ordering constraints.
   Identify actions that can run in parallel vs. must run sequentially.
3. EFFORT & IMPACT ESTIMATION
For each action:
   Estimate effort level (Low/Medium/High).
   Estimate expected impact on risk reduction.
   Apply rule-based effort adjustments when defined.
4. REMEDIATION PLAN GENERATION
Group actions into:
   immediate_0_30_days
   short_term_30_60_days
   medium_term_60_90_days
For each action include:
   entity_id
   action
   rationale
   dependencies
   sequencing_order
   effort_level
   expected_impact
   rule_applied (if any)
5. RISK REDUCTION SUMMARY
   Estimate total risk reduction per time window.
   Identify remaining high-risk entities after plan execution.
6. RULE CONFLICTS
Identify:
   rules that contradict recommended actions
   rules that override sequencing or grouping
   rules that cannot be applied
OUTPUT FORMAT
Return ONLY valid JSON using this schema:

```
{
  “remediation_plan”: {
    “immediate_0_30_days”: [
      {
        “entity_id”: “”,
        “action”: “”,
        “rationale”: “”,
        “dependencies”: [ ],
        “sequencing_order”: “”,
        “effort_level”: “”,
        “expected_impact”: “”,
        “rule_applied”: “”,
        “notes”: “”
      }
    ],
    “short_term_30_60_days”: [ ],
    “medium_term_60_90_days”: [ ]
  },
  “risk_reduction_summary”: {
    “immediate”: “”,
    “short_term”; “”,
    “medium_term”: “”,
    “remaining_high_risk_entities”: [ ]
  },
  “rules_applied”: [ ],
  “rule_conflicts”: [ ],
  “overall_notes”: [ ]
}
```

Return ONLY the JSON object. Do not include commentary.

An example response from the foundation model (122) to the remediations agent (175) for the above prompt is shown below:

```
    {
  “remediation_plan”: {
    “immediate_0_30_days”: [
      {
        “entity_id”: “srv-001”,
        “action”: “Apply critical OS and security
patches within 7 days”,
        “rationale”: “High vulnerability exposure and
recurring incidents indicate unpatched CVEs.”,
        “dependencies”: [“srv-001.network”,
“srv-001.storage”],
        “sequencing_order”: “1”,
        “effort_level”: “Medium”,
        “expected_impact”: “Significant reduction in
likelihood of service disruption and security
compromise.”,
        “rule_applied”:
“patching_rules.high_risk_assets”,
        “notes”: “Scheduled outside business hours due
to restart restrictions.”
      },
      {
        “entity_id”: “app-203”,
        “action”: “Implement automated incident
detection for Tier-1 services”,
        “rationale”: “Tier-1 applications require
enhanced monitoring to reduce MTTD and prevent
recurrence.”,
        “dependencies”: [ ],
        “sequencing_order”: “2”,
        “effort_level”: “Low”,
        “expected_impact”: “Improves detection speed
and reduces incident recurrence.”,
        “rule_applied”:
“monitoring_rules.tier1_services”,
        “notes”: “”
      }
    ],
    “short_term_30_60_days”: [
      {
        “entity_id”: “srv-014”,
        “action”: “Reduce vulnerability backlog by
prioritizing medium-severity patches”,
        “rationale”: “Backlog growth trend indicates
rising exposure; projected to enter high-risk category
in 30 days.”,
        “dependencies”: [ ],
        “sequencing_order”: “3”,
        “effort_level”: “Medium”,
        “expected_impact”: “Prevents escalation into
high-risk category.”,
        “rule_applied”: “”,
        “notes”: “”
      }
    ],
    “medium_term_60_90_days”: [
      {
        “entity_id”: “app-203”,
        “action”: “Optimize application latency by
reviewing service dependencies”,
        “rationale”: “Latency degradation and
dependency amplification increase impact and
operational instability.”,
        “dependencies”: [“srv-001”, “db-044”],
        “sequencing_order”: “4”,
        “effort_level”: “Medium”,
        “expected_impact”: “Improves performance
stability and reduces cascading failures.”,
        “rule_applied”: “”,
        “notes”: “Requires srv-001 patching to be
completed first.”
      }
    ]
  },
  “risk_reduction_summary”: {
    “immediate”: “High reduction expected due to
patching of srv-001 and monitoring improvements for
app-203.”,
    “short_term”: “Moderate reduction expected by
addressing vulnerability backlog on srv-014.”,
    “medium_term”: “Additional reduction expected from
dependency optimization for app-203.”,
    “remaining_high_risk_entities”: [
      “srv-001”
    ]
  },
  “rules_applied”: [
    “patching_rules.high_risk_assets”,
    “monitoring_rules.tier1_services”
  ],
  “rule_conflicts”: [
    {
      “rule”: “no_restarts_business_hours”,
      “conflict”: “srv-001 patching requires a
restart”,
      “resolution”: “Action scheduled for after-hours
maintenance window”
    }
  ],
  “overall_notes”: [
    “Plan prioritizes high-risk production assets
first.”,
    “Dependency sequencing ensures srv-001 remediation
precedes app-203 optimization.”,
    “Projected risk growth on srv-014 addressed before
escalation.”
  ]
}
```

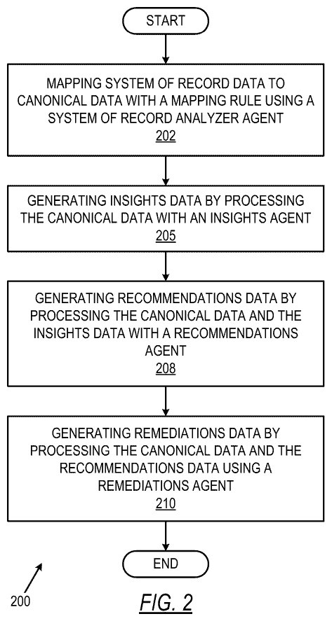

FIG. 2 shows a flowchart of a method for operational risk analysis using canonical data models and domain-specific agents. The method of FIG. 2 may be implemented using the systems described in the other figures, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the method (200) generates insights data, recommendations data, and remediations data from system of record data mapped to canonical data. The method (200) may include multiple steps (e.g., Block 202 through Block 210) that may execute on the components described in the other figures, including those of FIG. 1A, FIG. 1B, FIG. 7A, and FIG. 7B.

Block 202 involves mapping system of record data to canonical data with a mapping rule using a system of record analyzer agent. The system of record analyzer agent (155) receives the system of record data (152) and compares table names, column names, field value distributions, and relationship structures in the system of record data (152) to reference patterns associated with known systems of record stored by the operational assurance platform (102). The system of record analyzer agent (155) generates a confidence score for each comparison that indicates a degree of similarity between a field or entity in the system of record data (152) and a corresponding field or entity in the canonical data (162). When the confidence score for a comparison satisfies a threshold, the system of record analyzer agent (155) applies a mapping rule to transform the matched field or entity from the system of record data (152) into a corresponding canonical field or entity and writes the transformed data to the canonical data (162). The mapping rule specifies a source field identifier from the system of record data (152), a canonical field identifier in the canonical data (162), and transformation logic that converts values from a source format to a canonical format.

The method (200) may involve identifying unmapped data from a system of record using the system of record analyzer agent. The system of record analyzer agent (155) identifies unmapped data when the confidence score for a comparison does not satisfy the threshold, indicating a data underflow condition in which pattern matching did not produce a sufficient mapping for a portion of the system of record data (152). Unmapped data may include fields with custom naming conventions that do not correspond to reference patterns, entities stored in proprietary formats that differ from known system configurations, and relationship types that are absent from reference patterns maintained by the operational assurance platform (102). The system of record analyzer agent (155) generates a mapping request that identifies the unmapped fields, entities, and relationships and transmits the mapping request to the mapping rules agent (158).

The method (200) may involve generating a supplemental mapping rule for the unmapped data using a mapping rules agent. The mapping rules agent (158) receives the mapping request from the system of record analyzer agent (155) and accesses the unmapped portions of the system of record data (152) identified in the mapping request. The mapping rules agent (158) constructs a prompt that includes a description of the unmapped data, reference information from the canonical data model, custom rules and constraints associated with the organization, and instructions for generating mapping rules in a structured output format. The mapping rules agent (158) transmits the prompt to the foundation model (122) and receives a structured response formatted as JAVASCRIPT® Object Notation (JSON) that includes supplemental mapping rules specifying source field identifiers, canonical field identifiers, transformation logic, and confidence indicators for each mapping.

The method (200) may involve executing the supplemental mapping rule to update the canonical data with the unmapped data. The mapping rules agent (158) applies the supplemental mapping rules from the structured response to the unmapped portions of the system of record data (152) by executing the transformation logic specified in each supplemental mapping rule. The transformation logic may include normalization of field values to a canonical format, standardization of enumerated values across different systems of record, and renaming of fields from source field identifiers to canonical field identifiers. The mapping rules agent (158) writes the resulting transformed data to the canonical data (162), and the canonical data (162) stores a normalized representation of the system of record data (152) that includes both the data mapped by the system of record analyzer agent (155) and the data mapped by the mapping rules agent (158).

Block 205 involves generating insights data by processing the canonical data with an insights agent. The insights agent (165) selects a domain-specific template corresponding to a risk category selected through the client interface (128). The domain-specific template specifies fields from the canonical data (162) to include in a prompt, analysis instructions that direct the foundation model (122) to compute risk scores and key performance indicators from the selected fields, and output formatting constraints that specify a structured response format. The insights agent (165) constructs a prompt that includes the selected fields from the canonical data (162), the analysis instructions from the domain-specific template, and the output formatting constraints, and transmits the prompt to the foundation model (122). The foundation model (122) processes the prompt and returns a structured response formatted as JAVASCRIPT® Object Notation (JSON) that includes risk scores for individual entities, key performance indicators such as risk density and mean time to resolution, risk classifications that categorize entities into risk levels, and forward-looking risk projections for defined time horizons. The insights agent (165) stores the structured response as the insights data (168).

The method (200) may involve presenting multiple insights from the insights data. The client interface (128) receives the insights data (168) from the insights agent (165) and renders multiple insights on a display. The multiple insights may be presented as key performance indicators, risk score summaries, risk classification lists, and risk projection charts that represent the risk indicators computed from the canonical data (162). The client interface (128) presents the multiple insights in a selectable format that allows a user to select an insight from the multiple insights for further analysis.

Block 208 involves generating recommendations data by processing the canonical data and the insights data with a recommendations agent. The recommendations agent (170) receives the insights data (168) from the insights agent (165) and accesses the canonical data (162). The recommendations agent (170) constructs a prompt that includes the insights data (168), selected fields from the canonical data (162), recommendation generation instructions from a domain-specific template, and output formatting constraints. The recommendation generation instructions direct the foundation model (122) to identify root causes of risk indicators in the insights data (168), generate recommended actions that address the root causes, estimate expected impact on risk scores for each recommended action, estimate effort levels for each recommended action, and identify dependencies between recommended actions. The recommendations agent (170) transmits the prompt to the foundation model (122) and receives a structured response formatted as JAVASCRIPT® Object Notation (JSON) that includes a prioritized list of recommended actions organized by time horizon, where each recommended action includes an action description, a rationale, an expected impact indicator, an effort level indicator, and a list of dependencies. The recommendations agent (170) stores the structured response as the recommendations data (172).

The method (200) may involve generating the recommendations data responsive to selection of an insight of the multiple insights presented from the insights data. The client interface (128) receives a user selection of an insight from the multiple insights presented from the insights data (168). The client interface (128) transmits the selected insight to the recommendations agent (170), and the recommendations agent (170) constructs a prompt that incorporates the selected insight, associated fields from the canonical data (162), and recommendation generation instructions from a domain-specific template. The recommendations agent (170) generates the recommendations data (172) responsive to the selection by transmitting the prompt to the foundation model (122) and receiving a structured response that includes recommended actions targeted to the selected insight.

The method (200) may involve presenting multiple recommendations from the recommendations data. The client interface (128) receives the recommendations data (172) from the recommendations agent (170) and renders multiple recommendations on a display. The multiple recommendations may be presented as a prioritized list organized by time horizon, where each recommendation includes an action description, a rationale, an expected impact indicator, an effort level indicator, and dependency information. The client interface (128) presents the multiple recommendations in a selectable format that allows a user to select a recommendation from the multiple recommendations for remediation planning.

Block 210 involves generating remediations data by processing the canonical data and the recommendations data using a remediations agent. The remediations agent (175) receives the recommendations data (172) from the recommendations agent (170) and accesses the canonical data (162). The remediations agent (175) constructs a prompt that includes a selected recommendation from the recommendations data (172), selected fields from the canonical data (162), remediation planning instructions from a domain-specific template, and output formatting constraints. The remediation planning instructions direct the foundation model (122) to generate an execution plan that includes sequenced remediation steps, staffing and resource estimates, cost projections, dependency orderings, and executable remediation artifacts for the selected recommendation. The remediations agent (175) transmits the prompt to the foundation model (122) and receives a structured response formatted as JAVASCRIPT® Object Notation (JSON) that includes the execution plan and the executable remediation artifacts. The executable remediation artifacts may include patch deployment scripts, configuration update scripts, and automated workflow sequences that execute on target computing systems to apply patches, update configurations, and resolve identified risks. The remediations agent (175) stores the structured response as the remediations data (178).

The method (200) may involve generating the remediations data responsive to selection of a recommendation of the multiple recommendations presented from the recommendations data. The client interface (128) receives a user selection of a recommendation from the multiple recommendations presented from the recommendations data (172). The client interface (128) transmits the selected recommendation to the remediations agent (175), and the remediations agent (175) constructs a prompt that incorporates the selected recommendation, associated fields from the canonical data (162), and remediation planning instructions from a domain-specific template. The remediations agent (175) generates the remediations data (178) responsive to the selection by transmitting the prompt to the foundation model (122) and receiving a structured response that includes an execution plan and executable remediation artifacts targeted to the selected recommendation.

The method (200) may involve presenting multiple remediations from the remediations data. The client interface (128) receives the remediations data (178) from the remediations agent (175) and renders multiple remediations on a display. The multiple remediations may be presented as sequenced remediation steps, resource and staffing estimates, cost projections, dependency orderings, and descriptions of executable remediation artifacts. The client interface (128) presents the multiple remediations in a selectable format that allows a user to select a remediation from the multiple remediations for execution.

The method (200) may involve executing a remediation selected from the multiple remediations. The client interface (128) receives a user selection of a remediation from the multiple remediations presented from the remediations data (178). The operational assurance platform (102) executes the selected remediation by deploying an executable remediation artifact from the remediations data (178) to a target computing system. The executable remediation artifact may include a patch deployment script that installs a software patch on the target computing system, a configuration update script that modifies configuration settings on the target computing system, or an automated workflow sequence that executes a series of remediation steps on the target computing system. Execution of the executable remediation artifact modifies the target computing system by applying software patches that resolve known defects, updating system configurations that reduce error rates and failure conditions, or removing vulnerabilities that reduce attack surface area across the computing environment.

The method (200) may involve executing the system of record analyzer agent, the insights agent, the recommendations agent, and the remediations agent using multiple technology debt analysis templates. The technology debt analysis templates configure the system of record analyzer agent (155) to identify fields in the system of record data (152) related to hardware end-of-life dates, software end-of-support dates, unsupported protocols, and outdated system components. The technology debt analysis templates configure the insights agent (165) to compute risk scores based on technology debt indicators extracted from the canonical data (162), configure the recommendations agent (170) to generate recommended actions for technology refresh and modernization, and configure the remediations agent (175) to generate remediation plans that include upgrade schedules, procurement steps, and deployment scripts for replacing outdated technology components.

The method (200) may involve executing the system of record analyzer agent, the insights agent, the recommendations agent, and the remediations agent using multiple vulnerability analysis templates. The vulnerability analysis templates configure the system of record analyzer agent (155) to identify fields in the system of record data (152) related to unpatched operating systems, unpatched third-party applications, firmware versions, and architectural deficiencies. The vulnerability analysis templates configure the insights agent (165) to compute risk scores based on vulnerability exposure indicators extracted from the canonical data (162), configure the recommendations agent (170) to generate recommended actions for patch prioritization and vulnerability mitigation, and configure the remediations agent (175) to generate remediation plans that include patch deployment scripts, configuration hardening steps, and vulnerability resolution workflows.

The method (200) may involve executing the system of record analyzer agent, the insights agent, the recommendations agent, and the remediations agent using multiple operations analysis templates. The operations analysis templates configure the system of record analyzer agent (155) to identify fields in the system of record data (152) related to incident records, change records, problem records, alert thresholds, and system log entries. The operations analysis templates configure the insights agent (165) to compute risk scores based on operational indicators such as mean time to resolution, change failure rates, and incident recurrence rates extracted from the canonical data (162), configure the recommendations agent (170) to generate recommended actions for incident correlation, change management improvement, and operational workflow optimization, and configure the remediations agent (175) to generate remediation plans that include operational process updates, monitoring configuration changes, and automated incident response scripts.

The method (200) may involve executing the system of record analyzer agent, the insights agent, the recommendations agent, and the remediations agent using multiple performance analysis templates. The performance analysis templates configure the system of record analyzer agent (155) to identify fields in the system of record data (152) related to response times, latency measurements, resource utilization metrics, and capacity thresholds. The performance analysis templates configure the insights agent (165) to compute risk scores based on performance degradation indicators extracted from the canonical data (162), configure the recommendations agent (170) to generate recommended actions for performance tuning, capacity planning, and resource optimization, and configure the remediations agent (175) to generate remediation plans that include resource allocation adjustments, performance tuning scripts, and capacity expansion steps.

The method (200) may involve executing the system of record analyzer agent, the insights agent, the recommendations agent, and the remediations agent using multiple data protection analysis templates. The data protection analysis templates configure the system of record analyzer agent (155) to identify fields in the system of record data (152) related to backup schedules, replication status, access control configurations, recovery test results, and data classification records. The data protection analysis templates configure the insights agent (165) to compute risk scores based on data protection coverage indicators extracted from the canonical data (162), configure the recommendations agent (170) to generate recommended actions for backup coverage improvement, replication configuration updates, and access control remediation, and configure the remediations agent (175) to generate remediation plans that include backup policy updates, replication configuration scripts, and access control modification workflows.

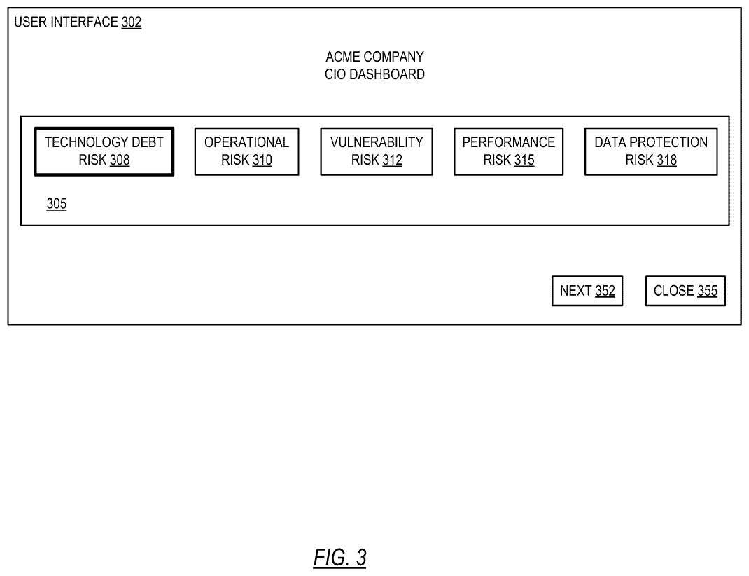

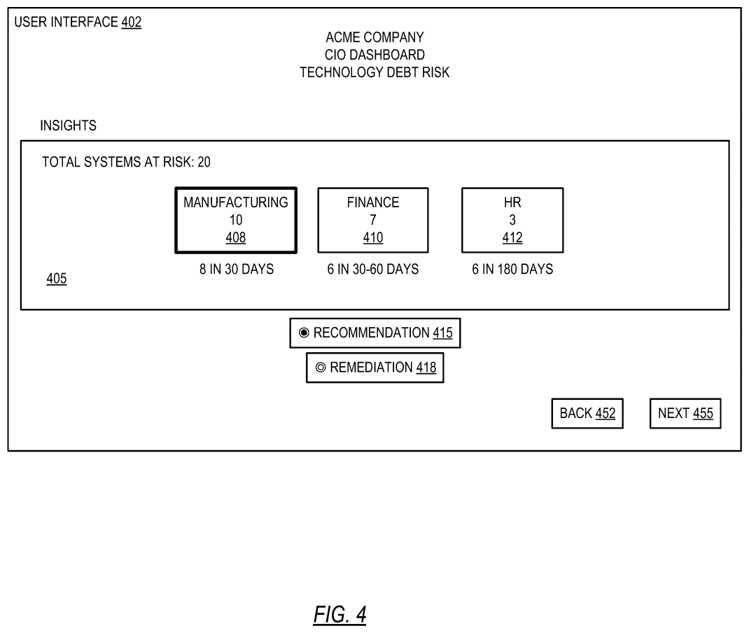

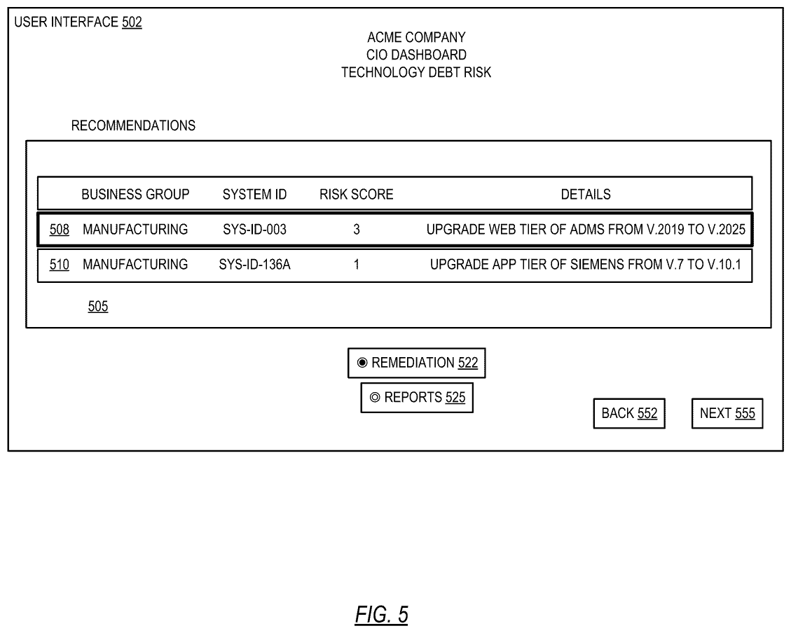

FIG. 3 through FIG. 6 show example user interface views presented through the client interface (128) of FIG. 1A for a technology debt risk analysis performed by the technology debt analysis application (105) using the analysis engine (118). FIG. 3 through FIG. 6 illustrate an example sequence in which a user navigates from a top-level operational risk dashboard through technology debt insights, recommendations, and remediations for systems managed by an organization.

Turning to FIG. 3, the user interface (302) presents a CIO dashboard for an organization labeled “Acme Company.” The user interface (302) displays the navigation region (305) containing interface elements including the technology debt risk element (308), the operational risk element (310), the vulnerability risk element (312), the performance risk element (315), and the data protection risk element (318). Each interface element (308, 310, 312, 315, 318) may correspond to one of the analysis applications (105, 108, 110, 112, 115) of FIG. 1A and is selectable to identify a type of operational risk analysis to perform. The technology debt risk element (308) is shown in a selected state, indicating that the user has selected technology debt risk for further analysis.

The user interface (302) includes the next control (352) and the close control (355). Selection of the next control (352) directs the client interface (128) to present a technology debt risk detail view, such as the user interface (402) shown in FIG. 4, that displays insights data generated by the insights agent (165) of FIG. 1B for the technology debt risk category. Selection of the close control (355) closes the user interface (302).

Turning to FIG. 4, the user interface (402) presents a technology debt risk view for the Acme Company CIO dashboard after selecting the technology debt risk element (308) and operating the close control (355) of FIG. 3. The user interface (402) displays an insights region (405) labeled “INSIGHTS” that presents a summary of technology debt risk across the organization. The insights region (405) indicates a total of twenty systems at risk and organizes the systems at risk by business group, including the manufacturing group element (408) indicating ten systems at risk, the finance group element (410) indicating seven systems at risk, and the human resources (HR) group element (412) indicating three systems at risk. The insights region (405) displays a time horizon associated with each business group, where the manufacturing group element (408) indicates eight systems at risk within thirty days, the finance group element (410) indicates six systems at risk within thirty to sixty days, and the HR group element (412) indicates six systems at risk within one hundred eighty days. The time horizons correspond to forward-looking risk projections generated by the insights agent (165) of FIG. 1B from the canonical data (162).

The user interface (402) includes the recommendation control (415) and the remediation control (418), which may be presented as radio buttons. The recommendation control (415) is shown in a selected state, indicating that a recommendation view is available for the insights presented in the insights region (405). Selection of the recommendation control (415) directs the client interface (128) to present a recommendations view, such as the user interface (502) shown in FIG. 5, that displays recommendations data generated by the recommendations agent (170) of FIG. 1B for the technology debt risk category. The remediation control (418) is selectable to direct the client interface (128) to present a remediations view, such as the user interface (602) shown in FIG. 6.

The user interface (402) includes the back control (452) and the next control (455). Selection of the back control (452) directs the client interface (128) to return to the CIO dashboard view of the user interface (302) shown in FIG. 3. Selection of the next control (455) directs the client interface (128) to present the recommendations view of the user interface (502) shown in FIG. 5 responsive to selection of the manufacturing group element (408).

Turning to FIG. 5, the user interface (502) presents a technology debt risk recommendations view for the Acme Company CIO dashboard after selection of the recommendation control (415) and the manufacturing group element (408) of FIG. 4. The user interface (502) displays the recommendations region (505) labeled “RECOMMENDATIONS” that presents a table of recommended actions for reducing technology debt risk in the manufacturing business group. The table includes columns for business group, system identifier, risk score, and details, and the table includes the row (508) and the row (510). The row (508) identifies a system “SYS-ID-003” in the manufacturing business group with a risk score of three and a recommended action to upgrade a web tier of ADMS from version 2019 to version 2025. The row (510) identifies a system “SYS-ID-136A” in the manufacturing business group with a risk score of one and a recommended action to upgrade an app tier of Siemens from version 7 to version 10.1. The row (508) is shown in a selected state, indicating that the user has selected the recommendation in the row (508) for further action. The recommended actions displayed in the recommendations region (505) correspond to recommendations data generated by the recommendations agent (170) of FIG. 1B from the insights data (168) and the canonical data (162) for the technology debt risk category.

The user interface (502) includes the remediation control (522) and the reports control (525), which may be presented as radio buttons. The remediation control (522) is shown in a selected state, indicating that a remediation view is available for the selected recommendation in the row (508). Selection of the remediation control (522) directs the client interface (128) to present a remediations view, such as the user interface (602) shown in FIG. 6, that displays remediations data generated by the remediations agent (175) of FIG. 1B for the selected recommendation. The reports control (525) is selectable to direct the client interface (128) to generate a report for the recommendations presented in the recommendations region (505).

The user interface (502) includes the back control (552) and the next control (555). Selection of the back control (552) directs the client interface (128) to return to the insights view of the user interface (402) shown in FIG. 4. Selection of the next control (555) directs the client interface (128) to present the remediations view of the user interface (602) shown in FIG. 6 responsive to selection of the row (508).

Turning to FIG. 6, the user interface (602) presents a technology debt risk remediations view for the Acme Company CIO dashboard after selection of the remediation control (522) and the row (508) of FIG. 5. The user interface (602) displays the remediations region (605) labeled “REMEDIATIONS” that presents a table of remediation steps for the selected recommendation to upgrade the web tier of ADMS from version 2019 to version 2025 for system SYS-ID-003 in the manufacturing business group. The table includes columns for business group, system identifier, step, and details, and the table includes the row (608) and the row (610). The row (608) identifies a first remediation step for system SYS-ID-003 in the manufacturing business group with a detail to run a script “WINSERVERUPG.PY” for Windows. The row (610) identifies a second remediation step for system SYS-ID-003 in the manufacturing business group with a detail to run the script “WINSERVERUPG.PY” for LINUX®. The row (608) is shown in a selected state, indicating that the user has selected the first remediation step for further action. The remediation steps displayed in the remediations region (605) correspond to remediations data generated by the remediations agent (175) of FIG. 1B from the recommendations data (172) and the canonical data (162) for the technology debt risk category, and the scripts referenced in the rows (608, 610) correspond to executable remediation artifacts generated by the remediations agent (175).

The user interface (602) includes the download artifacts control (622), the automatic execution control (625), and the reports control (628). The download artifacts control (622) is selectable to direct the client interface (128) to download the executable remediation artifacts referenced in the remediations region (605), including the script “WINSERVERUPG.PY” identified in the rows (608, 610) to execute the remediation at a future date. The automatic execution control (625) is selectable to direct the operational assurance platform (102) of FIG. 1A to execute the selected remediation step on a target computing system, such as deploying the script “WINSERVERUPG.PY” to the target computing system associated with system SYS-ID-003 automatically. The reports control (628) is selectable to direct the client interface (128) to generate a report for the remediations presented in the remediations region (605).

The user interface (602) includes the back control (652) and the close control (655). Selection of the back control (652) directs the client interface (128) to return to the recommendations view of the user interface (502) shown in FIG. 5. Selection of the close control (655) closes the user interface (602).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 7A, the computing system (700) may include one or more computer processor(s) (702), non-persistent storage device(s) (704), persistent storage device(s) (706), a communication interface (708) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) (702) may be one or more cores, or micro-cores, of a processor. The computer processor(s) (702) includes one or more processors. The computer processor(s) (702) may include a central processing unit (CPU), a graphics processing unit (GPU), a tensor processing unit (TPU), combinations thereof, etc.

The input device(s) (710) may include a touchscreen, keyboard, mouse, microphone, touchpad, electronic pen, or any other type of input device. The input device(s) (710) may receive inputs from a user that are responsive to data and messages presented by the output device(s) (712). The inputs may include text input, audio input, video input, etc., which may be processed and transmitted by the computing system (700) in accordance with one or more embodiments. The communication interface (708) may include an integrated circuit for connecting the computing system (700) to a network (not shown) (e.g., a local area network (LAN), a wide area network (WAN), such as the Internet, mobile network, or any other type of network) or to another device, such as another computing device, and combinations thereof.

Further, the output device(s) (712) may include a display device, a printer, external storage, or any other output device. One or more of the output device(s) (712) may be the same or different from the input device(s) (710). The input device(s) (710) and output device(s) (712) may be locally or remotely connected to the computer processor(s) (702). Many different types of computing systems exist, and the aforementioned input device(s) (710) and output device(s) (712) may take other forms. The output device(s) (712) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (702), is configured to perform one or more embodiments, which may include transmitting, receiving, presenting, and displaying data and messages described in the other figures of the disclosure.

The computing system (700) in FIG. 7A may be connected to, or be a part of, a network. For example, as shown in FIG. 7B, the network (720) may include multiple nodes (e.g., node X (722) and node Y (724), as well as extant intervening nodes between node X (722) and node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722) and node Y (724)) in the network (720) may be configured to provide services for a client device (726). The services may include receiving requests and transmitting responses to the client device (726). For example, the nodes may be part of a cloud computing system. The client device (726) may be a computing system, such as the computing system shown in FIG. 7A. Further, the client device (726) may include or perform all or a portion of one or more embodiments.

The computing system of FIG. 7A may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
mapping system of record data to canonical data with a mapping rule using a system of record analyzer agent;
generating insights data by processing the canonical data with an insights agent;
generating recommendations data by processing the canonical data and the insights data with a recommendations agent; and
generating remediations data by processing the canonical data and the recommendations data using a remediations agent.

2. The method of claim 1, further comprising:
identifying unmapped data from a system of record using the system of record analyzer agent;
generating a supplemental mapping rule for the unmapped data using a mapping rules agent; and
executing the supplemental mapping rule to update the canonical data with the unmapped data.

3. The method of claim 1, further comprising:
presenting a plurality of insights from the insights data; and
generating the recommendations data responsive to selection of an insight of the plurality of insights presented from the insights data.

4. The method of claim 1, further comprising:
presenting a plurality of recommendations from the recommendations data; and
generating the remediations data responsive to selection of a recommendation of the plurality of recommendations presented from the recommendations data.

5. The method of claim 1, further comprising:
presenting a plurality of remediations from the remediations data; and
executing a remediation selected from the plurality of remediations.

6. The method of claim 1, further comprising:
executing the system of record analyzer agent, the insights agent, the recommendations agent, and the remediations agent using a plurality of technology debt analysis templates.

7. The method of claim 1, further comprising:
executing the system of record analyzer agent, the insights agent, the recommendations agent, and the remediations agent using a plurality of vulnerability analysis templates.

8. The method of claim 1, further comprising:
executing the system of record analyzer agent, the insights agent, the recommendations agent, and the remediations agent using a plurality of operations analysis templates.

9. The method of claim 1, further comprising:
executing the system of record analyzer agent, the insights agent, the recommendations agent, and the remediations agent using a plurality of performance analysis templates.

10. The method of claim 1, further comprising:
executing the system of record analyzer agent, the insights agent, the recommendations agent, and the remediations agent using a plurality of data protection analysis templates.

11. A system comprising:
a computer processor; and
an application that, when executing on the computer processor, performs operations comprising:
mapping system of record data to canonical data with a mapping rule using a system of record analyzer agent,
generating insights data by processing the canonical data with an insights agent,
generating recommendations data by processing the canonical data and the insights data with a recommendations agent, and
generating remediations data by processing the canonical data and the recommendations data using a remediations agent.

12. The system of claim 11, wherein the application performs operations further comprising:
identifying unmapped data from a system of record using the system of record analyzer agent;
generating a supplemental mapping rule for the unmapped data using a mapping rules agent; and
executing the supplemental mapping rule to update the canonical data with the unmapped data.

13. The system of claim 11, wherein the application performs operations further comprising:
presenting a plurality of insights from the insights data; and
generating the recommendations data responsive to selection of an insight of the plurality of insights presented from the insights data.

14. The system of claim 11, wherein the application performs operations further comprising:
presenting a plurality of recommendations from the recommendations data; and
generating the remediations data responsive to selection of a recommendation of the plurality of recommendations presented from the recommendations data.

15. The system of claim 11, wherein the application performs operations further comprising:
presenting a plurality of remediations from the remediations data; and
executing a remediation selected from the plurality of remediations.

16. The system of claim 11, wherein the application performs operations further comprising:
executing the system of record analyzer agent, the insights agent, the recommendations agent, and the remediations agent using a plurality of technology debt analysis templates.

17. The system of claim 11, wherein the application performs operations further comprising:
executing the system of record analyzer agent, the insights agent, the recommendations agent, and the remediations agent using a plurality of vulnerability analysis templates.

18. The system of claim 11, wherein the application performs operations further comprising:
executing the system of record analyzer agent, the insights agent, the recommendations agent, and the remediations agent using a plurality of operations analysis templates.

19. The system of claim 11, wherein the application performs operations further comprising:
executing the system of record analyzer agent, the insights agent, the recommendations agent, and the remediations agent using a plurality of performance analysis templates.

20. A non-transitory computer readable medium comprising instructions executable by a computer processor to perform:
mapping system of record data to canonical data with a mapping rule using a system of record analyzer agent;
generating insights data by processing the canonical data with an insights agent;
generating recommendations data by processing the canonical data and the insights data with a recommendations agent; and
generating remediations data by processing the canonical data and the recommendations data using a remediations agent.
